(19) United States
(12) Patent Application Publication
(10) Pub. No.: US 2007/0021112 A1
(43) Pub. Date: Jan. 25, 2007

(54) Method and system for ensuring mobile data security

(75) Inventors: Paul Byrne, Los Altos, CA (US); Hideya Kawahara, Mountain View, CA (US)

Correspondence Address: DARBY & DARBY, P.C., P.O. BOX 5257, NEW YORK, NY, 10150-5257, US

(73) Assignee: Sun Microsystems, Inc.

(21) Appl. No.: 11/186,578

(22) Filed: Jul. 21, 2005

(51) Int. Cl. H04M 1/66; H04M 3/00; H04M 1/68; H04M 3/16; H04Q 7/20

(52) U.S. Cl. 455/419; 455/418; 455/411; 455/410

(57) ABSTRACT

In some embodiments systems and methods are provided for protecting data stored locally on mobile telecommunications or personal information devices. Data may be protected from loss by an automatic backup procedure implemented on a predetermined schedule or in response to a trigger. Information stored on a lost or stolen portable information device may be rendered inaccessible in response to a protective action directive. Access to locally stored information may be denied while emergency telecommunications service remains active.

### BACKGROUND

1. Field of the Invention

This invention relates to systems and methods for maintaining the security of data maintained on mobile telecommunications and portable information devices.

2. Description of the Related Art

Mobile telecommunications and portable information devices continue to develop, with service providers offering more features, services, and storage capacity. Users are increasing the amount of information stored on these devices, some of it quite sensitive. While the replacement costs of mobile telephones, personal digital assistants (PDAs), and multi-purpose devices decline, the value of the devices may be defined by the information contained in them. Data may be lost due to prolonged periods of power deprivation, exposure to inappropriate environments, and user error. In addition, the mobility of these devices, their very reason for being, makes them particularly vulnerable to loss and theft. Protecting data stored on such devices from loss and misappropriation is increasingly important.

Several methods are available to protect data stored on portable information devices from permanent loss. Many palmtop and handheld computers are designed to synchronize with a personal computer (PC), or with an online calendar, for example. Some mobile telephone service providers offer online address and phone books that can be synchronized with a handheld unit. While making such backup copies of data stored on mobile devices is rarely difficult, it requires the user to remember to do so. Furthermore, while much information can be synchronized, not all service providers offer online versions of each application found on the handheld unit, such as datebooks.

Data stored on subscriber information module (SIM) cards and other removable storage media can be copied to external storage devices to provide backup copies. However, this does not back up data stored in internal memory and, again, the user must make the effort to back up the data regularly.

Theft of mobile devices, particularly cell phones, is rampant. Wireless telecommunications service providers generally verify that the combination of the electronic serial number (ESN) and mobile identification number (MIN) of a mobile phone is valid each time a request is made to connect to their networks. Unauthorized users and mobile devices that have been reported stolen are typically denied access to the network. However, data stored locally on the device may still be at risk of unauthorized access.

Several approaches have been taken to data security. Passwords provide some protection, but are inconvenient and not impossible to break. Data stored on SIM cards can be separated from the mobile device by storing or transporting the SIM card separately, but this solution is even more inconvenient than a password. Nor does removing the SIM card protect data stored in the device's internal memory. Secure digital (SD) cards do not address security of data already on the card; the protocol merely prevents copying of copyrighted material.

### SUMMARY

Techniques have been developed to address the issue of securing information stored locally on mobile telecommunications devices, including portable information devices with telecommunications capabilities. Although some mobile telecommunications devices or networks offer facilities for a user to erase data stored on them, typically possession of the mobile telecommunications device is required. Even if it were possible to erase the data without having the portable unit in hand, the specter of permanent loss often makes this an unattractive response to the loss or theft of a mobile device, particularly if the user maintains some hope that the mobile telecommunications device may be recovered. Recognizing this dilemma, our techniques provide systems and methods for automatically implementing actions to ensure a current backup exists and, if appropriate, to then render information on the portable device inaccessible to unauthorized users.

In some realizations, these techniques provide a method for protecting information stored locally on a mobile telecommunications device or portable information device from loss due to misplacement, theft, exposure to inhospitable environments, trauma to the handheld unit, etc. In some cases a mobile telecommunications device automatically ensures that a current backup of the information stored locally exists in storage external to the mobile telecommunications device. In some cases, the automatic backup procedure occurs according to a predetermined schedule. In some realizations the schedule may be periodic. In some cases the schedule may be determined by the user. In some cases the schedule may be determined by the telecommunications service provider. In some cases, the automatic backup procedure occurs in response to a trigger signal. In some realizations, the techniques further provide a method for restoring information to local storage on the mobile telecommunications device unit after its recovery or to a substitute device designated by the user.

In some realizations, these techniques provide a method for protecting information stored locally on a mobile telecommunications device or portable information device from loss and unauthorized access. In some cases a mobile telecommunications device receives a protective action directive via a wireless communication network, ensures that a current backup of the information stored locally exists in storage external to the mobile telecommunications device, and in response to the protective action directive executes a protective action on the mobile telecommunications device that renders locally stored information inaccessible. In some cases, the locally stored information is rendered inaccessible by deleting it from local storage. In some cases, the locally stored information is rendered inaccessible by encrypting it in the local storage. In some cases, the locally stored information is rendered inaccessible by overwriting it in local storage.

In some implementations, the locally stored information is transferred to external storage, at least in part, via the wireless communication network. In some cases, the external storage containing the backup of locally stored information is maintained, at least partially, by a telecommunications service provider. In some cases, the external storage containing the backup of locally stored information is maintained, at least partially, by a telecommunications service subscriber.

In some implementations, a copy of at least some of the information stored locally on a mobile telecommunications device or portable information device is received via a wireless communication network and the mobile telecommunications device is supplied, also via the wireless communication network, with a protective action directive with instructions to the mobile telecommunications device to execute a protective action to render the locally stored information inaccessible.

In some implementations the invention provides a mobile telecommunications device having local storage for encoding a subscriber's information, a communications interface for receiving a protective action directive via a wireless communication network, and a functional sequence that can be executed on the mobile telecommunications device in response to a protective action directive to ensure that a current backup of locally stored information has been transferred to storage external to the mobile telecommunications device and then to render locally encoded information inaccessible.

In some implementations the invention provides a system for protecting information from loss and unauthorized access. In some configurations the system includes storage external to a mobile telecommunications device that encodes a backup of information stored locally on the mobile telecommunications device and a communications interface that can supply the mobile telecommunications device with a protective action directive via a wireless communication network. In some cases, such a protective action directive triggers a functional sequence executable on the mobile telecommunications device to ensure that a current backup of the locally stored information has been transferred to the external storage and then to render the locally stored information inaccessible. In some cases the system also includes the mobile telecommunications device and a computer-readable encoding of the functional sequence that can be executed on the mobile telecommunications device.

In some embodiments, the protective action directive is established using a networked computational service remote from the portable device. In some variations, the protective action directive is established without use of the portable device, while in others it is established via the portable device. In various realizations, the telecommunications network transmission and routing facilities may include a wireless voice network, a wireless data network, a packet-switched data network, an internet or intranet, a local- or wide-area network, a public switched telecommunications network (PSTN), or any combination thereof.

In some realizations, the techniques further provide a method for restoring access to information stored locally on the mobile telecommunications device unit after its recovery or return to function. In some cases, a copy of the backed-up information is transferred to the mobile telecommunications device or to a substitute device designated by the user. In some cases, the information stored locally is decrypted. In some cases, a password is provided to allow access to locally stored information.

The foregoing is a summary and thus contains, by necessity, simplifications, generalizations and omissions of detail. Consequently, those skilled in the art will appreciate that the foregoing summary is illustrative only and that it is not intended to be in any way limiting of the invention. The inventive concepts described herein are contemplated to be used alone or in various combinations. Other aspects, inventive features, and advantages of the present invention, as defined solely by the claims, may be apparent from the detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 depicts a system for protecting data stored on a mobile telecommunications device.

FIG. 2 depicts data storage on a mobile telecommunications device.

FIGS. 3A-3D are flow diagrams showing the process of initiating and implementing a date protection service including an automatic backup service for data stored on mobile telecommunications devices.

FIGS. 4A-4B are flow diagrams showing the process of initiating and implementing a data protection service including denial of access for data stored on mobile telecommunications devices.

The use of the same reference symbols in different drawings indicates similar or identical items.

### DESCRIPTION OF THE PREFERRED EMBODIMENT(S)

For clarity, the following descriptions may refer to particular mobile telecommunications devices, such as a mobile telephone or a multifunction device such as a smartphone or a handheld computer with wireless capability, but persons of ordinary skill in the art to which the invention pertains will no doubt understand that the general concepts described herein may find application to a multitude of mobile telecommunications devices. Mobile telecommunications devices currently in use include, among others, mobile telephones, personal digital assistants, pagers, palm-held computers, handheld computers, digital media players, communications-enabled portable devices, WAP-enabled portable devices, and iMode-enabled portable devices.

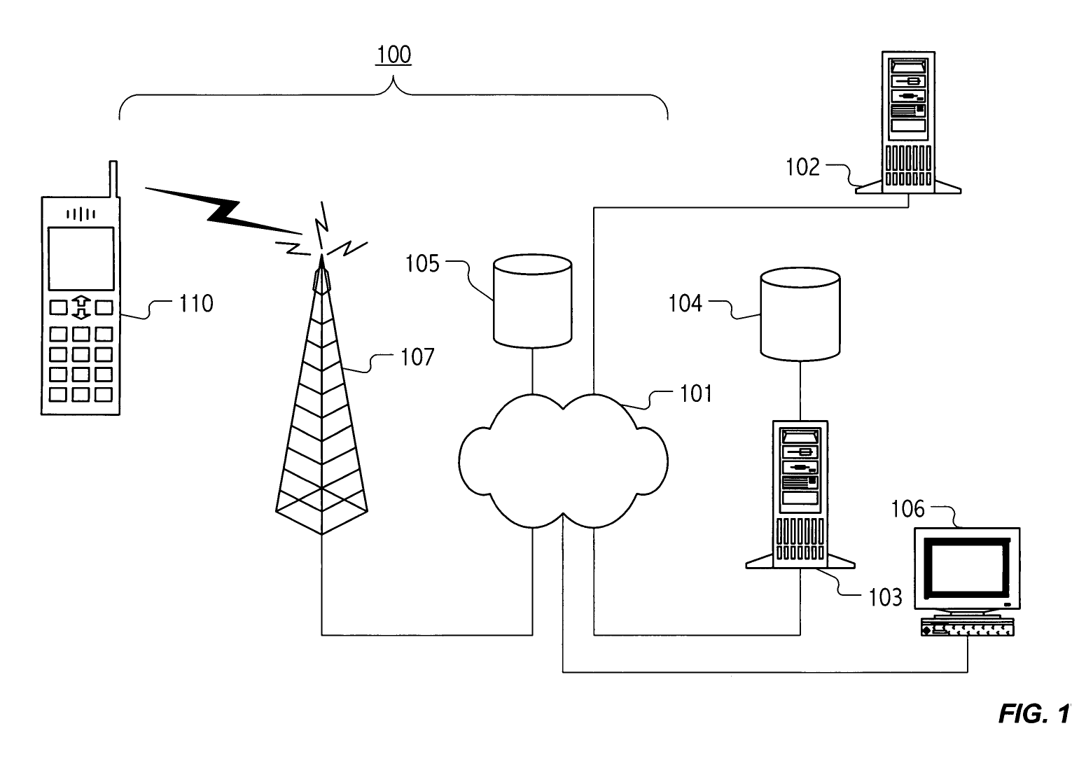

FIG. 1 depicts a system for protecting data stored on a mobile telecommunications device. In the illustration of FIG. 1, a telecommunications service provider operates telecommunications facilities 100, including a wireless communications network 101 with data storage capacity 105, in communication with send/receive facility 107, networked server 102, and networked server 103 with local storage 104. It should be understood that, although FIG. 1 shows an extremely simplified view, the actual telecommunications facilities 100 may include a suitable collection of network communications facilities such as servers, broadcast towers, storage devices, repeaters, and so forth, along with appropriate communications interfaces. Based on the description herein, persons of ordinary skill in the art will appreciate a wide variety of suitable configurations and alternatives. In the present simplified example, subscriber information may be stored external to the mobile telecommunications device on storage device(s) 104, 105 in one or more data stores addressable from the network 101, or forming part of the network. The data stores are queriable by issuing information requests, for example, from a client computer 106. A mobile telecommunications device 110, in this figure a mobile telephone, communicates with the wireless communications network 101 via send/receive facility 107 to exchange voice and/or data streams. All parts of the system need not be owned by a single telecommunications service provider; multiple parties may contribute services and facilities to the network or accessible by or through it. Indeed, the techniques described herein may be implemented as value-added services provided separate and apart from a particular telecommunications service or provider.

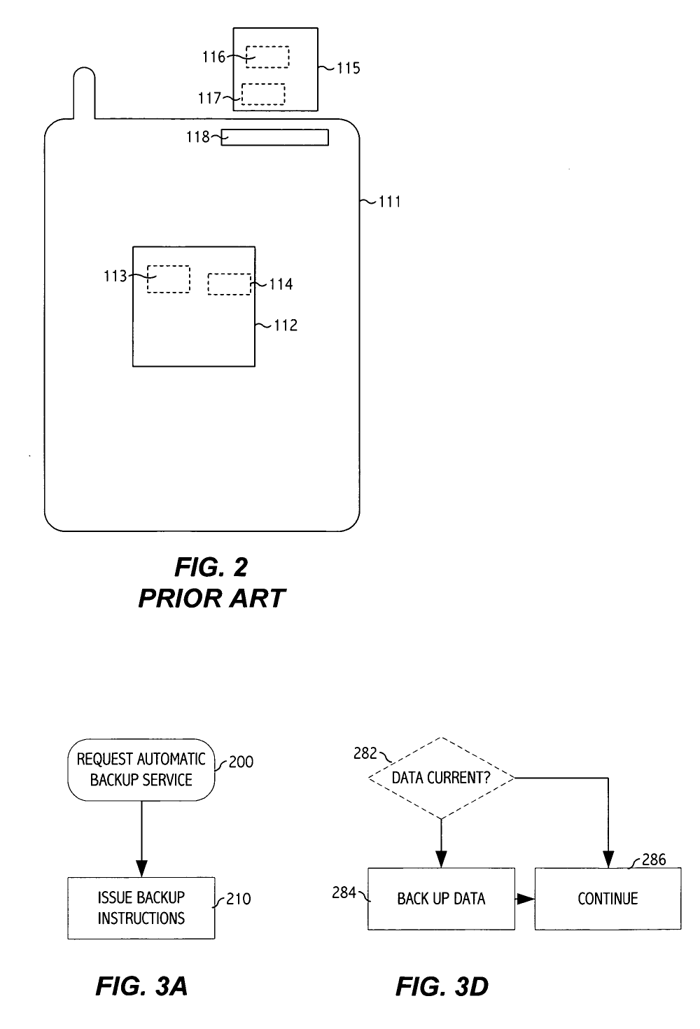

FIG. 2 depicts a possible information storage arrangement on a generalized prior art mobile telecommunications device 111, examples of which are enumerated elsewhere herein. The device has an internal data storage area 112 and a removable data storage area 115. Internal storage 112 is often referred to as “phone memory” (on mobile telephones and smartphones) or “internal memory.” Removable storage 115 is often referred to as “card memory” or “external memory” and may be, for example, a subscriber information module (SIM) card required for operation of the mobile telecommunications device 111, or it may be an optional expansion memory card, such as a secure digital (SD) memory card or a compact flash memory card or some other removable data storage device. When access to information stored on the removable storage 115 is desired, the removable storage 115 is connected to the mobile telecommunications device 111 by inserting it into a slot 118 in or on the device itself, or by attaching it to an external card reader (not shown) which then communicates with the mobile telecommunications device 111 by means of a wired or wireless, e.g., infrared or radio frequency, connection.

Internal storage 112 may contain multiple individual data entries 113, 114 of various types, such as system information, user-generated contact information, datebook information, text and spreadsheet files, electronic mail messages, and so on. Not all mobile telecommunications devices are capable of using external memory, but when present removable storage 115 may also contain multiple individual data entries 116, 117 of various types. Other information stored locally on the mobile telecommunications device may include data and programs either provided with the device or installed later to increase its functionality. Often date can be moved or copied from internal memory 112 to external memory 115, and vice versa. Information may be loaded into internal storage 112 and removable storage 115 by a number of methods, including direct entry from the mobile telecommunications device 111, entry into a personal computer (PC) followed by synchronization with the mobile telecommunications device 111, and entry into a web application followed by downlinking to the mobile telecommunications device 111. To facilitate entry of information directly into the handheld unit itself, the unit may be connected to a keyboard, keypad, or other data entry device by means of a wired or wireless, e.g., infrared or radio frequency, connection. Typically information stored locally may also be edited, encrypted, erased, and otherwise manipulated, depending on the capabilities of the handheld unit.

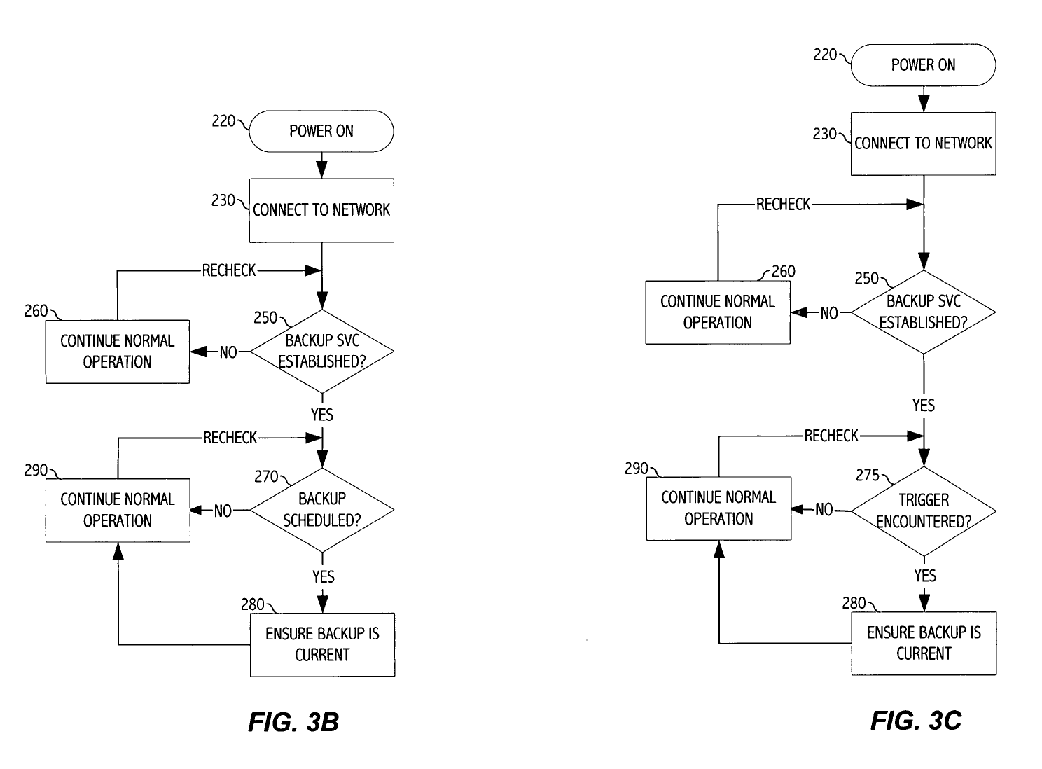

Individual data entries 113, 114, 116, and 117 may have value to the user of the mobile telecommunications device 111 in multiple dimensions. Depending on the type of information, a user might want to protect it from loss, misappropriation, or both. FIGS. 3A, 3B and 3C show exemplary processes a user might follow to protect data stored on a mobile telecommunications device from loss. Referring to FIG. 3A, the user requests automatic backup service 200 from the telecommunications service provider (or a third party), and issues backup instructions 210 to be stored by the service provider in a subscriber information store. The subscriber information store may be a dedicated store for backup instructions, or it may be part of a larger store of subscriber information containing data material to providing telecommunications services to the subscriber. If a user wishes to protect the information stored on a mobile telecommunications device from loss, the instructions might be to automatically make a backup copy of the locally stored information to a storage device external to the mobile telecommunications device. Alternatively, the backup instructions may simply be to confirm that a backup copy exists external to the mobile telecommunications device. The backup instructions may be issued by the subscriber in a number of ways. The subscriber may request the service on initial sign-up with the telecommunications service provider, including it as a subscription service much like text paging. The subscriber may request the service after storing significant amounts of personal data on the mobile telecommunications device 111. The subscriber may request the service in writing by mail, courier, or facsimile, by telephoning the telecommunications service provider using a wired or wireless telephonic connection; by sending an electronic mail (e-mail) message to the telecommunications service provider; by entering the request on a web site in communication with the telecommunications service provider's network; or by any other means offered by the telecommunications service provider. In some cases, no user request may be necessary as, for example, when the automatic backup service is provided by the telecommunications service provider as part of a bundle of services.

FIGS. 3B and 3C show examples of how such an automatic backup service can be implemented. When the mobile telecommunications device is powered up 220, a connection to the service provider's network 230 is established. In addition to the usual verification process used by service providers to prevent fraud, the system checks to see if backup service has been established 250. If not, normal operation of the device, including its communication with the wireless telecommunications network, continues 260, and the system may check again for establishment of automatic backup service on a schedule or when information on the mobile telecommunications device is changed or in response to some other triggering action. When automatic backup service has been established, however, the system checks whether it is time for a scheduled backup 270. If not, normal operations continue 290, and the system rechecks whether it is time for a scheduled backup 270. When it is time for a backup, the system ensures 280 that a backup of information stored locally on the mobile telecommunications device exists in storage (such as 104 or 105 of FIG. 1) external to the device 111, and then normal operations, including checking for time to perform backups, continue 290. FIG. 3C depicts the implementation when the step 280 of ensuring the currency of the backup occurs in response to the detection 275 of a trigger. The backup instructions may be followed continuously and in parallel with normal operations of the mobile telecommunications device, as can checking for the establishment of the automatic backup service. It may be advantageous in some realizations to transfer information, as part of the backup process, during periods when the mobile telecommunications device is otherwise idle.

As depicted in FIG. 3D, ensuring the currency of the backup may be accomplished by optionally checking to see if it is current 282 and if it is, continuing 286. If the backup is not current, a current backup is made 284, before continuing 286. Since it is always possible to dispense with checking 282 for currency of the data before making a copy 286, the step 282 of checking for currency is shown in a dotted-line box. The existence of a current backup may be ensured by comparing information stored locally on the mobile telecommunications device with information in storage external to it and confirming that both contain the same data and, if not, a copy of at least the newer information stored locally on the mobile telecommunications device 111 may be automatically transferred to external storage (such as 104 or 105 of FIG. 1) without further user action. Of course, in addition to the automatic backups, the user may choose to perform a manual backup of the locally stored information at any time. During the backup process a copy of all or some of the data stored locally on the mobile telecommunications device 111 is transmitted from the handheld unit and stored on a storage device (such as 104 or 105 of FIG. 1) separate from the handheld unit. More than one type of external storage may be used. In some cases external storage may be maintained by the telecommunications service provider and in some cases, by the telecommunications service subscriber. In some cases, for example when the backup is accomplished by synchronizing the portable information device with a computer, the currency of the backup is verified by checking a sync bit, or comparing the times of the last data change and the latest synchronization, or by another of the techniques commonly used to determine that a synchronization has been performed.

In some realizations, the automatic backup process is implemented on a schedule predetermined by the user or by the service provider. In some realizations, the automatic backup process is implemented on a periodic schedule. In some realizations, the automatic backup process is implemented in response to a trigger signal sent by the mobile telecommunications device, for example on power up of the mobile telecommunications device, during the power-down procedure when the mobile telecommunications device is turned off, when the mobile telecommunications device generates a low-battery alarm, or when the user makes a change to the locally stored information. In some realizations, the system may check for the presence of backup instructions on a schedule predetermined by the user or by the service provider, in response to a trigger signal as described with respect to the automatic backup process, during each routine verification process (as when moving from one cell to another of the wireless telecommunications network), or when someone attempts to access the locally stored information. Automatic backups may have multiple triggers and may be both scheduled and triggered. Of course, persons of ordinary skill in the art will no doubt be able to define, based on the teaching herein, other useful timings for automatic backup operations.

In some realizations, the automatic backup operation may make a complete copy of all data stored locally on the mobile telecommunications device 111 for storage on the network 101, or a storage device (such as 104 or 105 of FIG. 1) external to the mobile telecommunications device 111. In some implementations of the automatic backup service, it may not be necessary or desirable to back up all the locally stored information, particularly when transmission time or storage space is limited. For example, an entry containing the private telephone number of a major investor in one's business might be more important to back up than the telephone number of a balloon delivery service, which would be relatively easy to obtain from public sources should the user's copy be misplaced. In some implementations, only data that has been changed since the previous backup operation may be copied to external storage. When local storage contains both information stored by the user and information stored by a service provider or device manufacturer, it may be preferable to back up only the information stored by the user. In some cases the user may designate which information is to be backed up by means of a flag, or by choosing a particular storage location for the information. In some cases the user may designate that only information stored in internal memory 112 is to be backed up. In some cases the user may designate that information stored on removable storage 115 is to be backed up.

When a mobile telecommunications device is misplaced, lost, stolen, exposed to an inhospitable environment, or ceases to function, the backed-up information may be recovered by the user. The user may, for example, obtain a substitute mobile telecommunications device, which can then be designated to receive a copy of the backed-up information. The mobile telecommunications device supplier or the telecommunications service provider may provide the user with a substitute mobile telecommunications device, which may contain a copy of the backed-up information or which may be designated to receive a copy of the backed-up information. The substitute mobile telecommunications device may be the same model as the original device, although it need not be. On the felicitous occasion when the original mobile telecommunications device is located, returned, repaired, or resumes functioning it may be designated to receive a copy of the backed-up information.

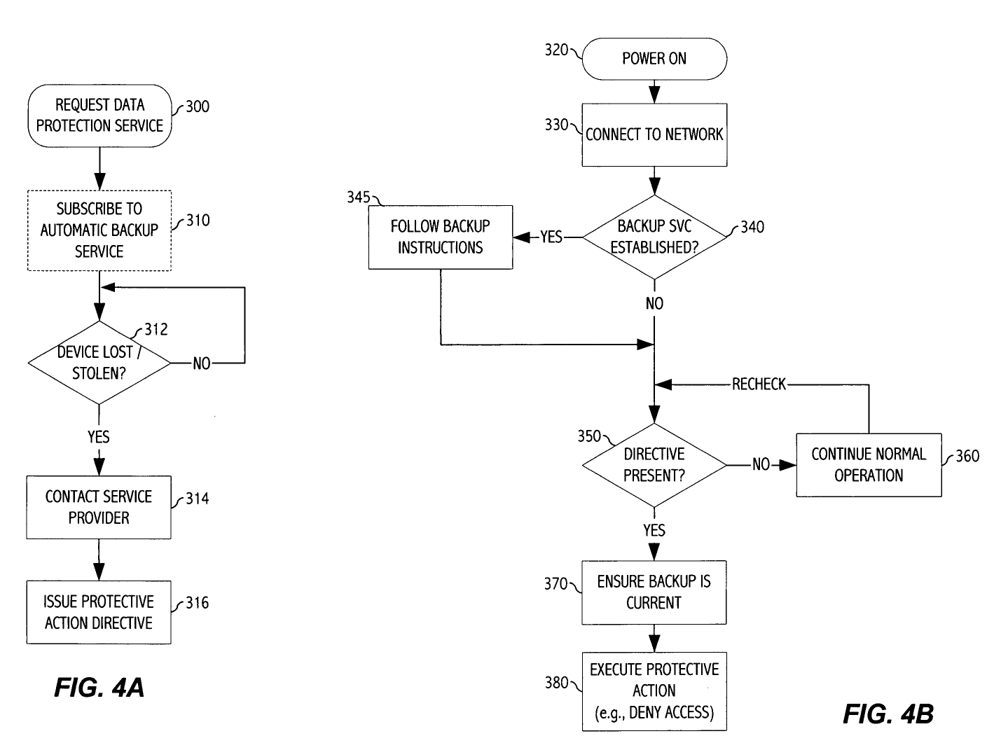

FIGS. 4A and 4B show an exemplary process a user can follow to protect information stored on a mobile telecommunications device from misappropriation or unauthorized access. Referring to FIG. 4A, the user requests data protection service 300 from the telecommunications service provider, and optionally subscribes 310 to an automatic backup service as described elsewhere herein. In some cases, no user request may be necessary as, for example, when the automatic backup service is provided by the telecommunications service provider as part of a default service package. Step 310 is optional, as indicated by the dotted-line box. When the loss or theft of the mobile telecommunications device is detected 312, the user contacts the telecommunications service provider 314 and issues a protective action directive 316.

FIG. 4B shows an example of how such an updated protective action directive can be implemented using a wireless telecommunications network. When the mobile telecommunications device is powered up 320, a connection to the service provider's network 330 is established. In addition to the usual verification process used by service providers to prevent fraud, the system checks 340 whether backup service has been established and, if so, ensures 345 the existence of a backup per the established instructions as described elsewhere herein. The backup instructions can be followed continuously and in parallel with normal operations of the mobile telecommunications device, as can checking for establishment of the backup service. The system also checks 350 for the presence of a protective action directive. If none is detected, normal operation of the device, including its communication with the wireless telecommunications network, continues 360, and the system continues to check for the presence of a protective action directive according to an established schedule or in response to triggering actions as described elsewhere herein. When a protective action directive is present, however, the system ensures that a current backup of information stored locally on the mobile telecommunications device 370 exists on storage external to it. The protective action directive may be stored or may be issued in real time, as when a subscriber calls to report a device theft, instructs an agent to execute the protective action, and the action is executed immediately. After the currency of the backup is ensured, the system executes any protective action 380 specified by the user, such as sending an instruction to the mobile telecommunications device 111 for it to execute an action denying access to all or part of the information stored locally 112, 115 on the mobile telecommunications device 111.

In some realizations, the system may check for the presence of a protective action directive on a schedule predetermined by the user or by the service provider, in response to a trigger signal as described with respect to the automatic backup process, during each routine verification process (as when moving from one cell to another of the wireless telecommunications network), or when someone attempts to access the locally stored information. Checking for the presence of a protective action directive may have multiple triggers and may be both scheduled and triggered. Of course, persons of ordinary skill in the art will no doubt be able to define, based on the teaching herein, other useful timings for checking for the presence of protective action directives.

Access to locally stored information may be denied in a number of ways. In some cases, the data may be erased from local storage, for example by a “Master Clear” or “Master Reset” command or by an erasure procedure. In some cases the data may overwritten. In some cases the information may be encrypted in place. In some cases, the updated protective action directive may reset or require a password to access locally stored information. In some cases the handheld unit may be equipped with means of generating, in response to a local command or one received from the telecommunications service provider, large electrical current or magnetic pulses that render the storage area(s) physically incapable of output operations. In some cases, emergency telephonic capabilities may be maintained while information stored on the mobile telecommunications device is rendered inaccessible. In some cases, a locational signal may be sent from the handheld unit as part of the updated protective action, instead of or in addition to information access denial.

As was described for the automatic backup procedure, it may not be necessary or desirable to deny access to all the locally stored information, particularly when time to complete the denial action is limited. In some cases the user may designate which information is to be rendered inaccessible by means of a flag or category or sensitivity level designation, or by choosing a particular storage location for the information. In some cases the user may designate that only information stored in internal memory 112 is to be rendered inaccessible. In some cases the user may designate that information stored on removable storage 115 is to be rendered inaccessible. Some users may choose to mark only certain entries 113, e.g. those containing sensitive personal data such as social security numbers or bank account information, for access denial. When local storage contains both data stored by the user and data stored by the service provider or device manufacturer, it may be preferable to deny access to only the data stored by the user.

As was described with reference to the automatic backup procedure, when a mobile telecommunications device is misplaced, lost, or stolen, the backed-up information may be recovered by the user although access to it from the handheld unit be denied. The user may, for example, obtain a substitute mobile telecommunications device, which can then be designated to receive a copy of the backed-up information now accessible from the substitute unit. The mobile telecommunications device supplier or the telecommunications service provider may provide the user with a substitute mobile telecommunications device, which may contain an accessible copy of the backed-up information or which may be designated to receive a copy of the backed-up information to be accessible from the substitute unit. The substitute mobile telecommunications device may be the same model as the original device, although it need not be. In the event that the original mobile telecommunications device is located or returned previously denied access to locally stored information may be restored. In some cases, to restore access to the locally stored information a copy of the backed-up information may be transferred to the mobile telecommunications device, to be stored locally. In some cases, access to the locally stored information is restored by a decryption procedure. In some cases, access to the locally stored information is restored by providing a password.

While the invention has been described with reference to various embodiments, it will be understood that these embodiments are illustrative and that the scope of the invention is not limited to them. Many variations, modifications, additions, and improvements are possible. Plural instances may be provided for components or operations described herein as a single instance. Boundaries between various components, operations and data stores are somewhat arbitrary, and particular operations are described in the context of specific illustrative configurations. Other allocations of functionality are envisioned and may fall within the scope of claims that follow. Structures and functionality presented as discrete components in the exemplary configurations may be implemented as a combined structure or component. These and other variations, modifications, additions, and improvements may fall within the scope of the invention as defined in the claims that follow.

What is claimed is:

1. A system for protecting information from unauthorized access, the system comprising:
storage external to a mobile telecommunications device, the external storage encoding a backup of the information stored locally on the mobile telecommunications device; and
a communications interface operable to supply the mobile telecommunications device with a protective action directive via a wireless communication network, the protective action directive configured to trigger a functional sequence executable on the mobile telecommunications device to ensure that a current backup of the locally stored information has been transferred to the external storage and to thereafter render inaccessible the locally stored information.

2. The system of claim 1,
wherein the transfer of the information to the external storage is at least partially via the wireless communication network.

3. The system of claim 1,
wherein the external storage is maintained, at least in part, by a telecommunications service provider.

4. The system of claim 1,
wherein the external storage is maintained, at least in part, by a telecommunications service subscriber.

5. The system of claim 1, the system further comprising:
the mobile telecommunications device and a computer-readable encoding of the functional sequence executable thereon.

6. The system of claim 1, the system further comprising:
a communications interface operable to transfer to a designated mobile telecommunications device at least a partial copy of the backup.

7. The system of claim 1, the system further comprising:
a communications interface operable to supply a designated mobile telecommunications device with a restoration directive via a wireless communication network, the restoration directive configured to trigger a functional sequence executable on the designated mobile telecommunications device to ensure that a semantically equivalent copy of the externally stored information exists on an internal storage of the designated mobile telecommunications device and to restore access to the locally stored information.

8. A method for protecting information from unauthorized access, the method comprising:
receiving, via a wireless communication network, for storage external to a mobile telecommunications device, at least a partial copy of the information stored locally on the mobile telecommunications device; and
supplying, via a wireless communication network, the mobile telecommunications device with a protective action directive configured to cause the mobile telecommunications device to execute a protective action rendering the locally stored information inaccessible.

9. The method of claim 8, wherein the protective action includes one or more of:
deleting the information from local storage of the mobile communications device.
encrypting the information in the local storage; and
overwriting the information in the local storage.

10. The method of claim 8, further comprising:
receiving a restore directive; and
in response to the restore directive, transferring the externally stored information to a designated mobile telecommunications device.

11. The method of claim 8, further comprising:
receiving a restoration directive; and
in response to the restoration directive, ensuring that a semantically equivalent copy of the externally stored information exists on an internal storage of the designated mobile telecommunications device and restoring access to the locally stored information.

12. A mobile telecommunications device comprising:
local storage for encoding information of a subscriber;
a communications interface operable to receive a protective action directive via a wireless communication network; and
a functional sequence executable on the mobile telecommunications device in response to the protective action directive to ensure that a current backup of the information exists on storage external to the mobile telecommunications device and to thereafter render inaccessible the information encoded in the local storage.

13. The device of claim 12,
wherein the mobile telecommunications device retains telecommunications functionality after the functional sequence is executed.

14. The device of claim 12, further comprising:
a communications interface operable to receive a restoration directive via a wireless communication network; and
a functional sequence executable on the mobile telecommunications device in response to the restoration directive to ensure that at least a partial copy of the backup exists on storage internal to the mobile telecommunications device and to restore access to the information encoded in the local storage.

15. A method for protecting information from unauthorized access, the method comprising:
storing information locally on a mobile telecommunications device;
receiving a protective action directive via a wireless communication network;
ensuring that a current backup of the stored information exists on storage external to the mobile telecommunications device; and
in response to the received protective action directive, executing on the mobile telecommunications device a protective action in accordance with the protective action directive, the protective action rendering the stored information inaccessible.

16. The method of claim 15, wherein the ensuring comprises:
automatically transferring a copy of the stored information to the external storage via the wireless communications network.

17. The method of claim 15, wherein the ensuring comprises:
confirming that the mobile telecommunications device has been synchronized with a computer more recently than the stored information has been changed.

18. The method of claim 15, wherein the ensuring comprises:
comparing the stored information with the current backup stored in the external storage; and
confirming that the two representations of information are semantically equivalent.

19. The method of claim 15,
wherein the stored information comprises less than all information stored on the mobile telecommunications device.

20. The method of claim 19,
wherein one or both of the set of information for which the backup is ensured and the set of information which is rendered inaccessible are selectable by a user.

21. The method of claim 15, further comprising:
receiving a restoration directive; and
in response to the received restoration directive, executing on the mobile telecommunications device an action in accordance with the restoration directive, the action restoring access to the stored information.

22. A method for protecting information from loss, the method comprising:
storing information locally on a mobile telecommunications device;
receiving a protective action directive via a wireless communication network;
automatically ensuring that a current backup of the stored information exists on storage external to the mobile telecommunications device.

23. The method of claim 22,
wherein the ensuring occurs in conjunction with a verification process.

24. The method of claim 22,
wherein the ensuring occurs on a predetermined schedule.

25. The method of claim 22,
wherein the ensuring occurs in response to a trigger signal from the mobile telecommunications device.

26. The method of claim 25,
wherein the trigger signal is sent by the mobile telecommunications device on power up.

27. The method of claim 25,
wherein the trigger signal is sent by the mobile telecommunications device when the mobile telecommunications device encounters a low-battery condition.

28. The method of claim 25,
wherein the trigger signal is sent by the mobile telecommunications device when information stored on the mobile telecommunications device is altered.

29. The method of claim 25,
wherein the trigger signal is sent by the mobile telecommunications device in response to an attempt to access the stored information.

30. The method of claim 22, further comprising:
subsequent to the ensuring and in response to the received protective action directive, executing on the mobile telecommunications device a protective action in accordance with the protective action directive, the protective action rendering the stored information inaccessible.

31. The method of claim 22, further comprising:
requesting restoration of the backup; and
receiving at least a partial copy of the backup on a designated mobile telecommunications device.
